(19) United States
(12) Patent Application Publication
(10) Pub. No.: US 2026/0210753 A1
(43) Pub. Date: Jul. 23, 2026

(54) SCALE SYSTEM

(71) Applicant: AptarGroup SAS, Louveciennes (FR)

(72) Inventors: Piers BARRIOS, Alencon (FR); Peter MCGEOUGH, Kells County Meath (IE)

(21) Appl. No.: 19/138,733

(22) PCT Filed: Dec. 15, 2023
(86) PCT No.: PCT/EP2023/086199

§ 371 Date: Jun. 13, 2025

(30) Foreign Application Priority Data
Dec. 16, 2022 (EP) 22214154.1

(51) Int. Cl. G01G 17/04; B01F 23/50; B01F 35/21; B01F 101/06; G01G 19/52; G01G 21/28; G01G 23/42

(52) U.S. Cl. CPC G01G 17/04; B01F 23/56; B01F 35/2117; G01G 19/52; G01G 21/28; G01G 23/42; B01F 2101/06

(57) ABSTRACT

A scale system for measuring a powder quantity including a base housing for stationary placement, a weighing surface movable relative to the base housing, and a weighing sensor that measures the mass of a powder container on the weighing surface. The scale system includes an evaluation device, which is configured to evaluate sensor data from the weighing sensor and to generate output data. The scale system includes a display device which is configured to output the output data. The scale system includes a receiving space for receiving a powder container, the bottom surface of the receiving space being formed by the weighing surface.

### FIELD OF APPLICATION AND PRIOR ART

The invention relates to a scale system for measuring a quantity of powder, in particular for measuring a quantity of powder for mixing baby food.

The preparation of infant formular and baby food, in particular baby milk, from powder requires a dosage of this powder. Usually, this dosing is done by measuring a dosing volume by means of a measuring scoop with a defined measuring scoop volume. For example, it is usual to mix 100 ml of heated water and four volumes of the measuring scoop of milk powder to produce 120 ml of baby milk.

However, this type of dosing is prone to errors. If the measuring scoop is overfilled, too much powder may be mixed with too little water. If the measuring spoon is not completely filled, for example because there is an empty area below a closed powder surface, then too little powder may be mixed with too much water. Furthermore, there is a risk that an error occurs regarding the numbering of filled scoops and too many or too little spoonfuls of powder are added to the water.

It is well known that scoop scales are used to control the amount of powder measured by the measuring scoop. However, scoop scales are difficult to handle and must be correctly aligned manually for correct measurement. In addition, a scoop scale cannot reliably prevent one full scoop too little or one full spoon too much of powder being mixed with the water due to miscount.

Measuring a powder quantity is not only used for baby food. There is also a similar need in other fields as in the area of adult nutrition, especially in the area of sports nutrition.

### OBJECT OF THE INVENTION

The object of the invention is to provide an advantageous possibility to be able to measure a product quantity in a simple and exact way, in particular a powder quantity of baby milk powder.

According to the invention, a scale system is primarily proposed for this purpose, which is designed in a special way to comprise or accommodate a powder container filled with powder.

A scale system according to the invention has a base housing for stationary placement. In particular, this base housing can be formed with feet made of rubber or plastic, so that it can be placed on a table or a kitchen surface without damaging the surface.

The scale system further comprises a weighing surface which is movable in a vertical direction relative to the base housing so as to be depressed by the weight force of a weighing product resting on the weighing surface.

To detect the mass of the weighing surface and the powder being placed thereon, the scale system has a weighing sensor that in particular measures the mass of a powder container filled with powder that can be placed on the weighing product surface. The weighing sensor can, for example, be a force sensor or a pressure sensor.

The scale system also has an evaluation device, which is designed to evaluate sensor data from the weighing sensor and to generate output data, which is then being output on a display device.

In the state of use, the powder is resting on the weighing surface, preferably in a disposable powder container, which in particular preferably simultaneously represents the delivery packaging of the powder. For example, it can be a metallic can or a disposable plastic container. Further details on possible containers are explained in further detail below. In addition to the scale system for receiving such a container, the invention also relates to a set which, in addition to the scale system, comprises at least one such powder container.

The powder container remains on the weighing surface for a longer period of time during the use of the scale system and during the removal of powder, so that with increasing removal of powder from the container, the reduction in the weight of the container and the remaining powder is detected by the weighing sensor. Based on the detected weight, the scale system generates output data that is output to the display device.

The scale system according to the invention is intended in particular for measuring a quantity of powder, whereby granules are also understood within the meaning of powder according to this invention. In principle, use for other non-powdery products is also possible, for example for liquid or highly viscous cream-like products. Additional to the main aspect of the invention concerning the use with powder, the invention also comprises, according to a secondary aspect, a scale system for measuring said other products and in particular liquids. Insofar powder is referred to in the context of the description, this equally includes the other products mentioned above and in particular liquid products in case the scale system is intended or designed for said other products.

Preferably, it is provided that the evaluation device is configured to determine during a stepwise removal of a partial mass from the weighing surface the partial mass already removed in course of the specific removal operation by comparing the mass currently measured by the weighing sensor with a previously recorded reference mass prior to the beginning of the removal operation. On basis of said partial mass already removed the evaluation device generates output data displays said output data on the display device. Said output data reflects the partial mass removed since the recordation of the reference mass and comprises an increasing output value representing the removed partial mass. With the progressive removal of further powder from the powder container, this output value increases stepwise.

The scale system according to the invention is thereby able to inform the user which powder quantity he has already removed, for example for the production of one current bottle of baby milk. As the removal progresses, the value increases. As soon as the user has removed the intended amount of powder, he ends the removal. Advantageously the user gets a specific signal once a sufficient mass of powder has been removed.

The risk of using too little or too much powder is thereby reduced. The danger of the user miscounting the number of scoops already removed is also reduced. The user can check the current status of the removal on the display device. Even if the measuring scoop is not filled correctly, or if the powder is not taken with a measuring scoop of defined volume, but for example by means of an ordinary tablespoon, the user can record on the display device the amount of powder already removed and check whether further powder is required.

Said value, which is generated by the evaluation device, and which is output as part of the output data from the display device, can in the simplest case be the powder mass removed since the reference mass was recorded in grams. For example, if a mass of 3.6 grams of powder is taken as a single volume of measuring scoop and if three spoonfuls of powder are being removed, the output value increases from 0 to 3.6, then from 3.6 to 7.2, and finally from 7.2 to 10.8.

However, it is preferable that the value corresponds to a number of mass units stored in the evaluation device or calculable by the evaluation device, or that such a value on basis of said mass unit is output in addition to the simple mass value described above. A mass unit can correspond in particular to that mass which of the scoop filling quantity of a defined level scoop, such a measuring scoop preferably being part of the scale system. The size of the unit mass preferably is between 2 grams and 10 grams. Referring to a milk powder with 500 grams/liter, for example, a mass unit of 3.6 grams corresponds to a spoon filling quantity of 7.2 cm³.

The size of a mass unit can be permanently stored in the evaluation device. It is also possible that several different mass units are stored there, corresponding to different measuring scoops. Alternatively, the size of the mass unit can also be calculated by the evaluation device, for example, by calculating the mass per spoonful volume on the basis of a known spoonful volume stored in the evaluation device and additionally using a density value specific to the current powder. Usually, infant formular powder has a density between 0.4 g/cm³ and 0.5 g/cm³.

Using a mass unit, which corresponds to the level scoop filling volume of a measuring scoop, the output value generated by the evaluation device and displayed on the display device increases from 0 to 1, then from 1 to 2, and finally from 2 to 3, when three spoonfuls of powder are removed.

Although this number of full spoonsful is usually an integer number when removing intended scoop fill quantities, the value can also be displayed in the form of a decimal fraction, depending on the configuration of the evaluation device. For example, a value of 0.8 can be displayed if the powder quantity of an incompletely filled measuring scoop is removed from the container.

The measuring scoop associated with the scale system preferably has a scoop volume of between 1 cm³ and 30 cm³, in particular between 4 cm³ and 9 cm³. It can be advantageous to use a relatively heavy spoon, for example a metallic spoon with a mass of 20 grams or more, in order to detect its separation from a scoop holder described below.

The scale system preferably has a leveling rim, which is preferably not provided on the disposable container itself, but on the scale system separate from the container. By means of this leveling rim, excess powder can be wiped from the measuring scoop, so that the measuring scoop has a level powder surface as intended.

For the measuring scoop associated with the scale system, a scoop holder is preferably provided on the scale system, by which or in which the measuring scoop is stored when not in use. The scoop holder can be provided on the base housing or stationary relative to the weighing surface, whereby this also includes a holder on a lid which is stationary relative to the weighing surface when the lid is closed. In particular, the scoop holder can be provided on an inner side of the lid. Suitable holders for the scoop can be provided for magnetic adhesion of the measuring scoop or also for clamping reception of the measuring scoop. In the case of a clamping holder, the holder is preferably at least partially made of an elastomer material which is elastically deformed to accommodate the measuring scoop.

Preferably, the evaluation device is not only configured to generate the output value for display on the display device, but also to determine the partial mass of a single removal in the course of the stepwise increase of the removed partial mass, and to compare the partial mass of the single removal with an expected mass of a scoop volume full of powder. The evaluation device is therefore able to compare the powder mass taken in the course of a single removal with a mass value, which corresponds to a correctly filled measuring scoop and which can be stored in the evaluation device or be calculated by the evaluation device, taking into account the powder density. A deviation of the powder mass of the single removal from the expected powder mass represents an indication of incorrect use of the measuring scoop.

The detection of a deviation can be signaled to the user by the evaluation device, for example by an acoustic signal generator. In particular, the signaling may be provided by the display device. For example, the display device can indicate to the user whether the measuring scoop is overfilled or underfilled or if more scoops are taken than intended. The display device can show this in text form or by means of a symbol graphic. Furthermore, it can be provided that the display device contains a further action instruction for the user, for example an instruction to pour the contents of the incorrectly filled scoop back into the powder container and to try again.

As described above, the determination of the powder mass removed is carried out by a comparison of the mass detected by means of the weighing sensor and the reference mass stored before the start of the removal operation. The reference mass can be determined immediately at the start of the use of the scale system by reading out the weighing sensor. Preferably, however, the reference mass is already determined at the end of the previous usage and stored in a memory of the evaluation device.

The evaluation device is designed to detect the start of use of the scale system, for example, in order to determine the reference mass in response thereto and/or in order to activate a removal mode in response thereto, wherein in said removal mode the described evaluation of the removed mass and the display on the display device takes place. In particular, the weighing sensor can be activated in response to the beginning of the usage.

The evaluation device can detect the beginning of the usage of the scale system, for example, on the basis of the opening of a lid of the scale system. This can be done by a sensor provided on the lid or a locking device, or it can be done by the weighing sensor of the scale system. An additional acceleration sensor can also be used for detecting the opening of the lid. Furthermore, a movement of the scale system as a whole, for example due to its positioning on a table surface, can also be detected by the weighing sensor or an additional sensor and used to detect the beginning of usage. Furthermore, the separation of the measuring scoop from the lid can also be detected in order to recognize the beginning usage. The separation of the measuring scoop from the lid can be detected, for example, by a correspondingly reduced mass detected by the weighing sensor. Furthermore, a first partial removal of powder can also be detected and interpreted as the start of usage.

Apart from a recognition of the beginning of the usage by the described sensors, also a manually start function can be provided, by which the user changes the evaluation device to a removal mode and/or makes the evaluation device measure the reference mass. The start function can be initiated, for example, by a hardware button on the scale system or by a software button on a touchscreen or in an app on a connected smartphone.

For the described functionality of the evaluation device, it is sufficient to store data on the partial removals during a removal operation, for example during the removal of three scoops to be filled into a baby bottle. Preferably, however, the evaluation device stores the data for a plurality of removal operations over a longer period of time, in particular the data for all removal operations from a powder container starting from its initial opening until it is empty and replaced.

This data on the past removal operations can be output via the display device. Also, evaluations concerning missed removal operations and/or statistics to powder quantities deviating from the intended powder quantity can be provided. If a smartphone is being used to facilitate the removal operation, it is also possible to store data on who conducted the removal operation and thus pre-pared the baby food.

The invention relates to the design of the scale system with a receiving space for receiving an ex-changeable powder container, wherein a bottom surface of the receiving space is formed by the weighing surface.

In such a design, the scale system does not have a weighing surface which is freely accessible from all sides, but it is fully or essentially closed forming said receiving space, such that the powder container can be fully inserted into the receiving space. The weighing surface forms the bottom surface of the receiving space. The powder container is preferably inserted from above. Once inserted, the powder container is protected by the receiving space when not in use. In order to access the powder, the receiving space can be opened, preferably using a lid.

Preferably, the receiving space is surrounded circumferentially by a receiving space wall. This wall can be provided stationary on the base housing. Preferably, however, it is fixed to the weighing surface and thus movable relative to the base housing together with the weighing surface. In this case, the mass of the peripheral receiving space wall also bears on the weighing sensor. In particular, preferably at least part of the receiving space wall is integrally connected to the weighing product surface. The weighing surface and a part of the receiving space wall are then formed by an upwardly open and preferably cup-like receptacle, into which the powder container can be inserted from above. The receiving space preferably has a cylindrical shape. Its base can be round, but it can also have a different shape and be for example rectangular.

On the upper side opposite the weighing surface, a removable or displaceable lid is preferably provided, by means of which the receiving space can be opened in order to remove powder from the powder container and closed when not in use. This allows the powder to be protected when not in use. Preferably an own cover of the powder container is not placed back on the container after insertion of the powder container in the receiving space, but instead the lid delimiting to the top side of the receiving space protects the powder in the powder container.

The lid can be movably provided at an upper end of the receiving space wall. In particular, it can be movable pivotably having a hinged lid with the hinge being provided at the upper end of the receiving space. In this case, it is preferably provided that a snap-locking device is provided opposite the lid hinge for securing the lid in the closed state, said snap-locking device preferably provided in the form of a pivotable snap-locking tab on the receiving space wall or on the lid. A snap-locking device allows the lid to be closed particularly tightly. Preferably, a sealing component is provided on the lid or opposite it on a contact edge to provide a secure sealing in the closed state.

In one particular design of the receiving space wall, the receiving space wall is modular so that the receiving space can be variably configured with respect to its size. This can be achieved by joining two receiving space wall elements, one of which being available in different sizes as part of the scale system. A preferred design is one in which at least three receiving space wall elements are provided, wherein the size of the receiving space can be varied by using or not using at least one of the three receiving space wall elements. In particular, in a design having three receiving space wall elements, it may be provided that a first receiving space wall element is connectable to a second receiving space wall element and the second receiving space wall element is connectable to a third receiving space wall element by respective identical coupling means, for example by threaded means. Therefore, the second receiving space wall element can be fully removable to reduce the size of the receiving space and the first receiving space wall element can then be directly connected to the third receiving space wall element.

Preferably, it is provided that the receiving space wall is formed by at least two separable wall parts, which can be separated from each other for the purpose of removing a powder container and for the purpose of inserting a powder container. The wall parts can be identical with the above-described receiving space wall elements. However, a wall part can also be formed jointly by several and in particular of two receiving space wall elements.

In such a design with at least two separable wall parts, it is preferably provided that an upper one of the two wall parts has an inner diameter which is smaller than that of the powder container. When the two wall sections are connected after insertion of the container, the container is thus secured in the receiving space and cannot be removed out of the receiving space through upper wall part.

In the case of such two wall parts, which are separated for the purpose of inserting the container, it is advantageous if the wall parts can be connected to each other by a threaded connection. Preferably, the wall components are formed at least in sections as circular-cylindrically shaped wall parts for this purpose.

Alternatively, the wall parts can also be connected by a snap connection. In particular, a snap connection is preferred in the case of a non-circular cylindrical receiving space, for example in the case of a receiving space with a square or rectangular cross-section, in which a threaded connection is difficult to implement.

Preferably, the receiving space wall is provided with a wall window. Through the wall window, imprints on the inserted powder container can be read.

In use, the scale system is equipped with a container in which the powder, in particular infant formula, is contained and which preferably is the delivery packaging of the powder. This container is arranged on the weighing surface during operation.

Various types of containers can be used in a scale system according to the invention. Potential containers may have walls which are at least partially made of metal. In particular, a container body is preferably made of metal and in particular as a metal can, while a removable lid can also made of metal or of plastic. In another design the powder container is made partially or as a whole of plastic. In particular, it may be a multilayer plastic body forming the container body.

A particularly preferred form of a powder container used with the scale system according to the invention is made partly or entirely of cardboard and/or other paper or another cellulose-based material. Such a powder container represents a particularly environmentally friendly design and is easy to recycle. The powder container is protected against external influences by the receiving space of the scale system, so that thin and flexible paper walls can be sufficient in regular use.

Basically, two types of containers are possible, namely on the one hand powder containers with flexible walls in the manner of a powder bag, and on the other hand powder containers with rigid walls, which form a container body with essentially fixed dimensions. A powder bag needs a smaller amount of material and is therefore usually a more environmentally friendly solution, in particular in case of a bag of paper.

The powder container preferably has a closure element, which closes the container in the delivery state of the powder container and which is removed prior to the insertion into the receiving space. The closing element is no longer required after insertion of the container into the receiving space, since the powder contained in the container is protected from outside influences by the receiving space walls and the lid from the time of insertion into the receiving space.

A scale system according to the invention can be formed by a single structural unit thus forming the main unit, the basic housing of which preferably comprising the evaluation device and the display device. A preferred design is one in which the scale system comprises two subunits, namely a main unit comprising at least the base housing and the weighing surface and the weighing sensor, and an additional unit comprising at least the display device. Preferably, the additional unit is a computer, a tablet computer, a smart watch or, in particular, a smartphone equipped with an app connected to the main unit via a wireless network interface. The display device of the additional unit may be provided instead of a display device on the base housing. However, designs are possible in which a display device is also provided on the base housing. Preferably, at least one output device in the form of an LED or a loudspeaker is provided on the base housing.

The scale system, in particular its additional unit which preferably is a smart phone, can be connected to the Internet, in order to exchange data with a server on the internet. The scale system is preferably designed to initiate ordering processes concerning new powder containers. Preferably, the ordering process or a signaling to the user preceding the ordering process takes place as a function of a mass of the remaining powder detected by the weighing sensor. In case of an existing Internet connection, the scale system can also be designed to download data on different types of powder containers from the Internet, for example, in order to receive the powder density and/or dosage specifications for them and, if necessary, to use this information in the course of the evaluation by the evaluation device. The Internet connection also allows product authentication to be carried out in order to check originality criteria of an existing powder container.

The evaluation device, which evaluates the sensor data from the weighing sensor and generates the output data on the basis of this, can, in one possible design, be arranged completely in the main unit, in particular in the base housing. Accordingly, the main unit is fully functional on its own.

Alternatively, the evaluation device can also be subdivided into two evaluation subunits, one evaluation subunit in the main unit and one evaluation subunit in the additional unit. In such a design, it is thus provided that the generation of the output data for the display device takes place with the participation of both the main unit and the additional unit, and thus in particular of a smartphone. The evaluation subunits preferably each have a processor and memory. They preferably communicate via a wireless network such as WIFI or Bluetooth. They evaluation subunits can also be separately connected to the Internet and communicate with each other via the Internet.

In one possible embodiment, the acquisition of sensor data from the weighing sensor and possibly other sensors of the main unit is performed by the main unit and its evaluation subunit. The sensor data or a mass value determined on the basis thereof is then transmitted to the additional unit and its evaluation subunit, where further evaluation takes place, in particular the conversion into a value representing the removed mass or the removed scoop volumes and/or the check whether the mass of a partial removal corresponds to the mass to be expected on the basis of the measuring scoop. Alternatively, however, it can also be provided that the generation of the output value already takes place on the evaluation subunit of the main unit and is transmitted to the additional unit for the purpose of the displaying only.

The scale system can be designed in such a way that, at least on the main unit, it has no further sensor besides the weighing sensor. In addition to the actual detection of the mass of the remaining powder containers, the weighing sensor can also take over other functions, such as the detection that a removal operation has been started. With suitable evaluation, the weighing sensor can also be used, for example, to detect the opening of the lid or the changing of the container. A main unit with only one weighing sensor allows a relatively low production price.

However, the scale system, in particular its main unit, can also be equipped with at least one further sensor. This may, for example, be a sensor designed to detect a marking applied to the container, in particular an RFID reader or an optical sensor. This can be used to record data about the powder in question or to check the originality of the powder. However, instead of a sensor on the main unit, existing sensors of the smartphone used as an additional unit can also be used for this purpose.

Furthermore, a further sensor can also be provided on the main unit for mechanical detection of the opening of the lid, for example a switch or an acceleration sensor. An acceleration sensor can also detect the handling of the main unit regardless of a lid movement.

Preferably, the evaluation device, or the evaluation subunit on the main unit, can be operated in a power saving mode in which at least the weighing sensor is deactivated or not monitored, but parts of the evaluation subunit are in operation, the evaluation subunit being adapted to terminate the power saving mode in response to the detection of a manual activation or in response to specific sensor data from other sensors and thus to activate the weighing sensor. In particular, this can be done in response to the detection of a movement, determined by an accelerometer sensor.

The scale system, or in particular an app that is part of the scale system and which is executed on a smartphone, can also have supplementary functions in connection with the removal of powder, in addition to the main scale function. In particular, the scale system can have a signaling mechanism that indicates by signaling an upcoming planned removal of powder. This signaling can take place optically, acoustically and/or haptically via a vibrator. The scale system has furthermore preferably a logging mechanism, which logs the removal of powder and/or the expected, but missing removal of powder due to a time schedule deposited in a memory, in order to output this data or data derived therefrom on the display device. This can also include recommendations regarding the handling of the scale system.

For the purpose of easy cleaning, it is advantageous if the scale system or its main unit can be disassembled without tools. In particular, preferably the base housing and/or the weighing surface is separable from each other and/or from the weighing sensor. Preferably, the main unit has an electronic module enclosed by a housing, said module comprising all or at least the majority of the electronic components of the main unit and being separable as a whole from the base housing.

The scale system, in particular its main unit, can have a battery in order not to have to be permanently connected to an external power source. For powering the scale system and/or for charging said battery, a power connector is preferably provided on the main unit, in particular in the form of a USB power connector.

### BRIEF DESCRIPTION OF THE DRAWINGS

Further advantages and aspects of the invention are described and shown in the claims and in the following description of preferred embodiments of the invention, which are explained below with reference to the figures.

FIG. 1 shows a first embodiment of a scale system according to the invention with its partial components.

FIG. 2 shows a sectional view of the main unit of the scale system.

FIG. 3 shows the structure of the main unit with an exploded view of its components.

FIG. 4A to 4C illustrate the insertion of a powder container into the main unit.

FIG. 5 and 5A to 5F illustrate an exemplary removal operation, in the course of which three spoonfuls of powder are removed from a powder container while this process is monitored.

FIG. 6 shows an alternative design of a main unit.

FIGS. 7A and 7B show the alternative main unit of FIG. 6 during the insertion of a powder container.

### DETAILED DESCRIPTION OF THE EMBODIMENTS

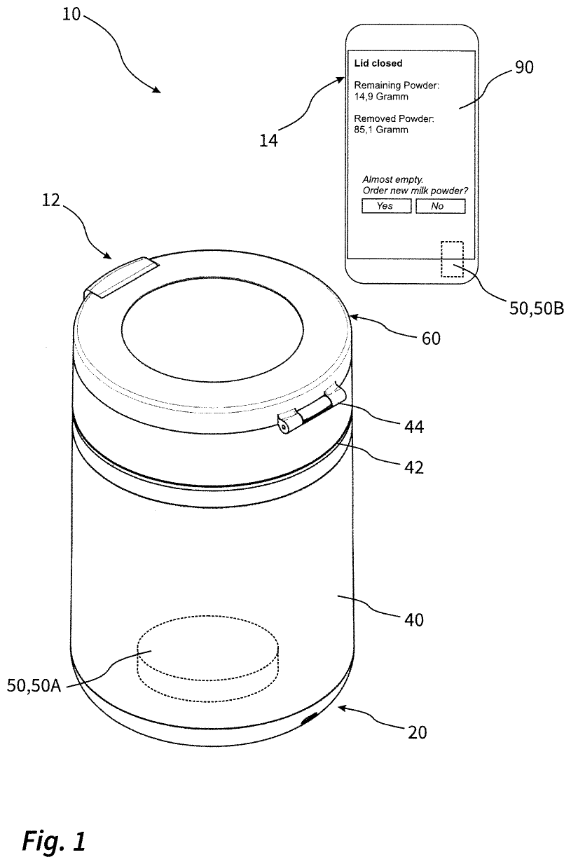

FIG. 1 shows a scale system 10 according to the invention comprising a main unit 12 and an additional unit 14 in the form of a smartphone.

The scale system 10 is intended for handling infant formular in powder form and for allowing easy powder dosing, in particular in course of the preparation of baby milk.

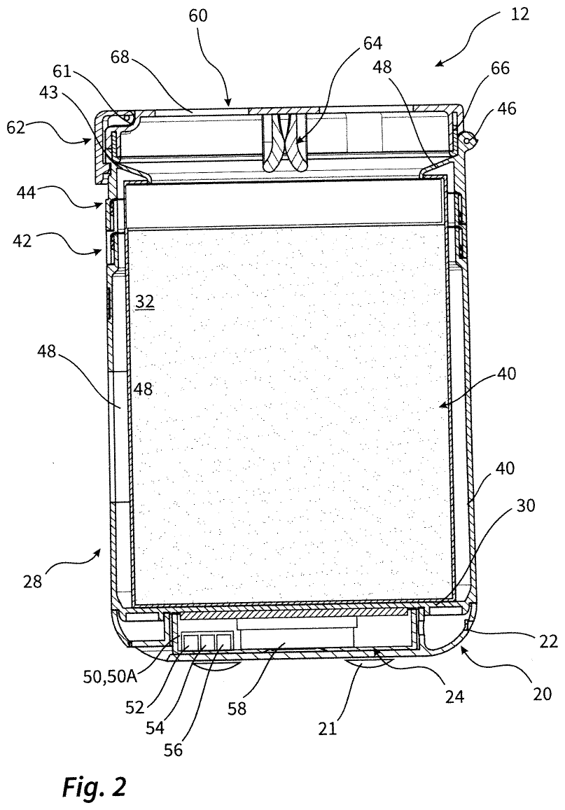

For this purpose, the main unit 12 is designed to receive a powder container 80. The main unit, which is shown in a sectional view in FIG. 2, has a flat base housing 20 with rubber feet 21. An electronics module 24 is located in a central recess of the base housing, which can be connected to a power source through an opening 22 in the base housing.

The electronics module 24 carries on its upper surface a cup-shaped receptacle 28, which is formed primarily by a weighing surface 30 and integrally therewith by a substantially cylindrical receiving space wall part 40. This receiving space wall part 40 is adjoined by a second receiving space wall part 42 and a final receiving space wall part 44. A hinged cover 60 is attached to the receiving space wall part 44, which can be pivoted by means of a hinge 46 and which has an outer part 61 and a sealing component 66 inserted therein. Opposite the hinge 46, the lid 60 is provided with a snap-lock device 62 getting in locking engagement with the receiving space wall part 44 when the lid 60 is closed.

On the inside of the lid 60, a scoop holder 64 is provided for receiving a measuring scoop. Furthermore, the lid 60 is provided with recesses forming lid windows 68. Additionally, the receiving space wall part 40 is provided with a viewing window 48.

Together, the weighing surface 30, the receiving space wall parts 40, 42, 44 and the lid 60 surround a receiving space 32. When the lid 60 is closed, the receiving space is essentially closed and thus protected against the ingress of moisture.

A powder container 80 is inserted into the receiving space 32. This powder container 80 is preferably a powder container 80 to be used only once and to be replaced once empty. The powder container 80 is formed by the packaging the powder has been sold/delivered in. As soon as the powder container 80 is empty, it is disposed and replaced by a new powder container 80. It is also possible to directly use the cup-like receptacle 28 as a powder container and to empty the powder into this re-usable cup-like receptacle 28 in order to use it as powder container.

The lid 60 is opened when the removal of powder from the powder container 80 is intended. It can be swung open after opening the snap-lock device 62. Powder can then be removed from the powder container 80 with the measuring scoop, whereby it can be ensured by means of a leveling rim 45 that the measuring scoop 18 is levelled full at each removal.

In order to hold the powder container 80 securely in the receiving space 32, the upwardly terminating receiving space wall part 44 has an inwardly pointing retaining web 43. The inside diameter of the retaining web 43 is smaller than the powder container 80, so that the powder container 80 is secured in the receiving space 32.

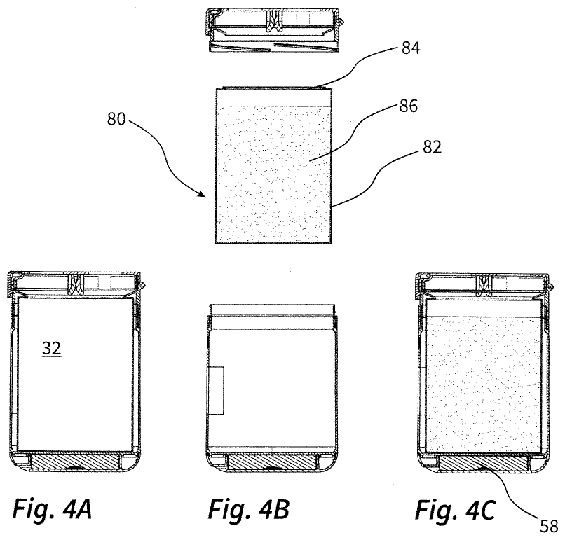

In order to remove the powder container 80 and to insert a new powder container 80, the multi-part design of the receiving space wall parts 40, 42, 44 is used. FIGS. 4A to 4C illustrate this. The receiving space wall parts 42, 44, which are connected by a thread, are separated from each other, so that the receiving space 32 is accessible. Then, in the manner shown in FIG. 4B, the new powder container 80 containing powder 86 is inserted. However, a closing element 84 is first separated from a container body 82 of the powder container 80. Subsequently, the receiving space wall part 44 together with the lid 60 is screwed on, whereby a centering of the powder container 80 takes place due to the conical shaping of the retaining web 43. FIG. 4C shows the situation after insertion of the new powder container 80.

If a powder container with a smaller height is inserted, it is possible to remove the receiving space wall part 42 and to directly connect the receiving space wall parts 40 and 44 to each other.

Referring to the condition of FIG. 4C, the weighing sensor 58, which is part of the electronics module 24, detects the mass of the weighing surface 30 resting on it, together with the powder container 80 resting on it, as well as the receiving space wall parts 40, 42, 44 and the lid 60 together with the removal scoop 18 fastened in it.

Sensor data from the weighing sensor 58 is processed by a processor 52, which is supplied with electrical power by a battery 54 and which is in communication with the additional unit 14 shown in FIG. 1 by means of a wireless network interface 56. The processor 52 is adapted to further process the data acquired by the weighing sensor 58 and to transmit it to the additional unit 14. The further processing by the processor 52 of the main unit 12 can be of different types depending on the intended distribution of tasks between the evaluation subunits 50A, 50B.

The evaluation device 50 as a whole is designed to display the weight force detected by means of the weighing sensor 58 in a manner helpful for the removal operation on a display device 90. In particular, the display device 90 is the display of the smartphone 14, for which purpose an app as part of the weighing system 10 is preferably executed on the smartphone.

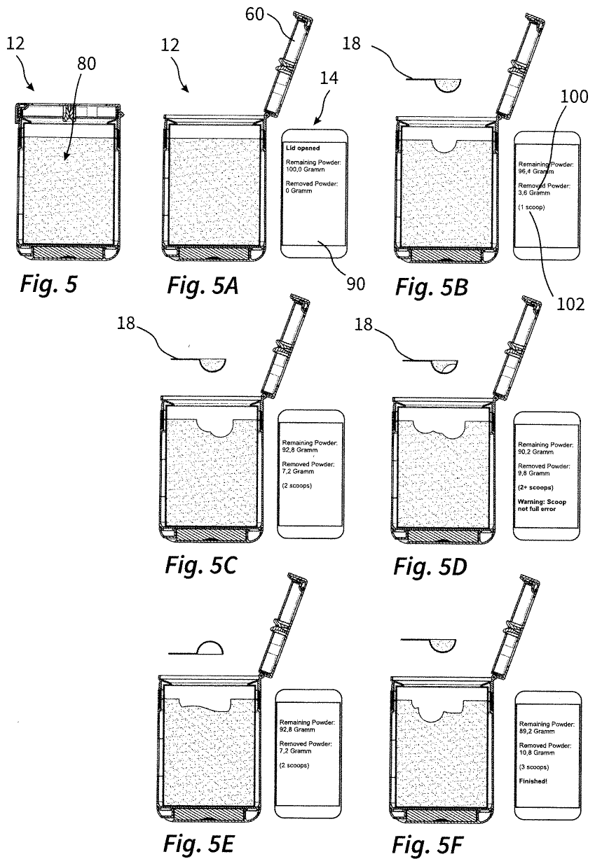

This is explained in detail with reference to FIGS. 5 to 5F.

FIG. 5 shows the initial state after insertion of the new powder container 80. In this state, the weighing sensor 58 measures a mass of 265 grams as an example. This is the sum of the mass of the weighing surface 30, the receiving space wall parts 40, 42, 44 and the lid 60 of a total of 100 grams, the mass of the measuring scoop of 15 grams, the mass of the powder container of 50 grams and the mass of the powder itself of a total of 100 grams. In a memory of the evaluation device 50, a current mass value is stored as reference mass, preferably the powder mass value of 100 grams calculated on the basis of 265 grams.

As shown in FIG. 5A the lid 60 is opened to start the removal operation, namely to take three full scoop volumes form the powder container resulting in 10.8 grams of milk powder to prepare 90 ml of baby milk.

The main unit 12 is opened by pressing the snap-lock device 62. This results in a characteristic change in the force detected by the weight sensor 58. The processor 52 processes this change. In response thereto, or in response to a subsequent separation of the measuring scoop 18 and a measurement thereof by the weighing sensor 58, the evaluation device 50 assumes that a removal operation has started. Accordingly, information regarding the current removal operation appears on the display device 90.

The information shown on the display device 90 includes an indication of the amount of powder of 100 grams that is currently still available. This value initially corresponds to the stored reference mass value. Initially, 0 grams is still displayed on the display device 90 as the powder quantity removed.

As shown in FIG. 5B, the measuring scoop is now filled for the first time and freed of excess powder by means of the levelling rim 45. As soon as a constant measured value is again obtained at the weighing sensor 58, the evaluation device 50 recognizes that the remaining mass has been reduced by 3.6 grams, whereby this corresponds to the removed mass of the measuring scoop volume with the measuring scoop correctly filled. The remaining mass of 96.4 grams is displayed on the display device, as well as the information that 3.6 grams have been removed and that this corresponds to one scoop.

FIG. 5C shows the situation after the remaining mass has also been reduced by further 3.6 grams during the second removal. This corresponds to the mass to be expected with two correctly measured scoop volumes. Accordingly, the display device also shows the indication that this corresponds to two scoops in addition to the summed removal of 7.2 grams.

FIG. 5D shows a third removal, which is, however, incorrect. As can be seen in the figure, the measuring scoop 18 is not completely filled, as it has a powder-free area below the surface that is difficult for the user to see.

The evaluation device 50 recognizes that not the expected further 3.6 grams have been removed, but instead only 2.6 grams. This information is shown on the display device. A visually highlighted message is displayed that the powder mass of the last removal does not correspond to that expected. Alternatively or additionally, this can be signaled acoustically and/or by means of a signal LED. In particular, preferably, a loudspeaker is provided as part of the electronic module 24, which indicates the non-expected removal by a warning tone.

The user hereby recognizes the error and pours the scoop contents back into the container 80, as is illustrated in FIG. 5D. The data as after the second removal of FIG. 5C appears again on the display device 90.

The user then removes another spoonful of powder from the powder container 80 and makes sure that the scoop is completely filled this time. The evaluation device 50 recognizes from the mass detected by the weighing sensor 58 that the expected mass of 3.6 grams has now been removed, and displays the resulting value on the display device 90. Furthermore, it can also indicate here that the desired total quantity has now been removed from the powder container 80 and thus the removal operation shall end. Preferably, this is also acoustically indicated by the aforementioned loudspeaker of the electronic module 24.

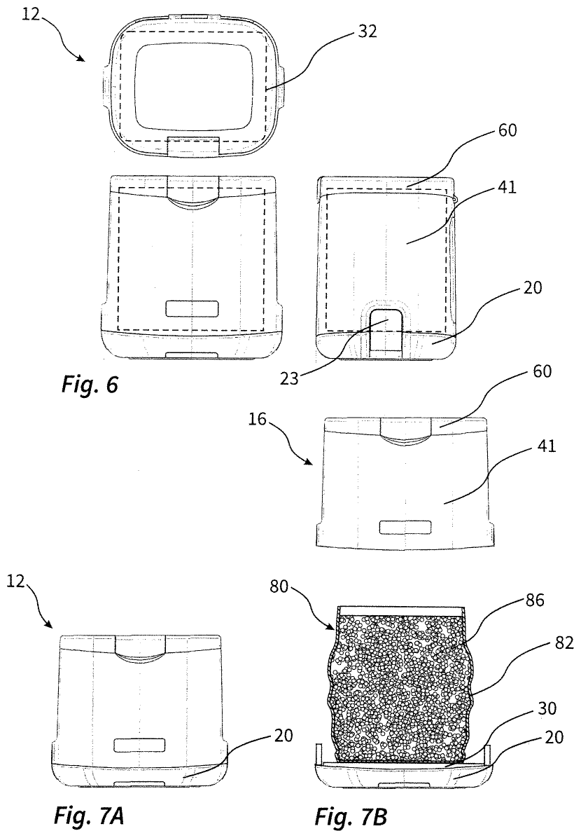

FIGS. 6 and 7A and 7B show an alternative version of the main unit 12. One essential difference to the main unit 12 of the preceding figures is that the main unit 12 of FIGS. 6 and 7A and 7B defines a cuboid-shaped receiving space 32. Another essential difference is that, for inserting a powder container 80, an upper part 16 of the main unit 12 can be removed, which comprises the entire surrounding receiving space wall 41 as well as the lid 60.

Once this upper part 16 has been lifted, the powder container 80 can be positioned on the weighing surface 30. In particular, it can be a powder container 80 with paper walls, which has an advantageous inherent stability due to its cuboid shape. After the powder container 80 is correctly arranged, the receiving space 32 is closed again by putting on the upper part 16.

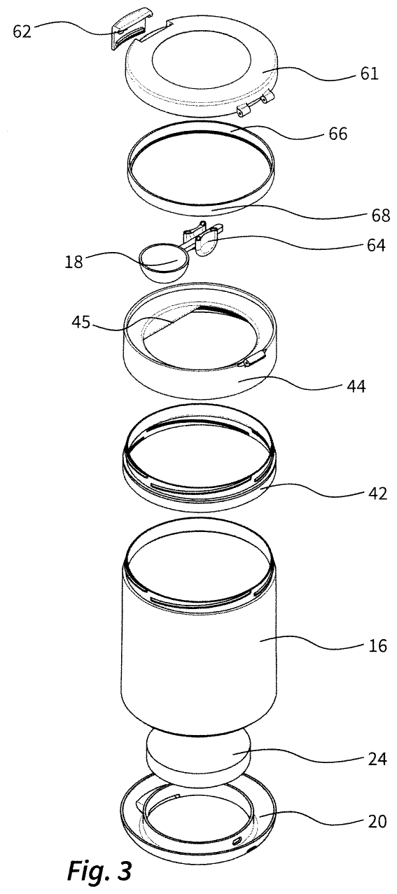

The upper part 16 is then fastened to the base housing 20 by means of snap locks 23. This results in a further difference to the design of FIGS. 1 to 4. Unlike there, in the main unit 12 of FIGS. 6 and 7A and 7B, the upper part 16 together with the lid 60 does not rest on the weighing sensor 58.

1. A scale system for measuring a powder quantity, the scale system comprising:
a base housing for stationary placement;
a weighing surface movable relative to the base housing;
a weighing sensor that measures the mass of a powder container on the weighing surface;
an evaluation device configured to evaluate sensor data from the weighing sensor and to generate output data;
a display device configured to output the output data; and
a receiving space for receiving a powder container, the receiving space having a bottom surface formed by the weighing surface.

2. The scale system according to claim 1, wherein:
the receiving space is circumferentially surrounded by a receiving space wall; and
on an upper side opposite the weighing surface the receiving space includes a removable or displaceable lid, the lid, in a closed state, closing off the receiving space at a top thereof.

3. The scale system according to claim 2, wherein
the lid has a lid window disposed to permit viewing into the powder container from above.

4. The scale system according to claim 2, wherein
the lid or a contact edge of the receiving space wall includes a sealing component sealingly isolating the receiving space when the lid is in the closed state.

5. The scale system according to claim 2,
wherein the lid is disposed pivotably movably at an upper end face of the receiving space wall.

6. The scale system according to claim 5, further including
a snap-locking device for fixing the lid in the closed state, the snap-locking device being disposed on the receiving space wall or on the lid.

7. The scale system according to claim 2, wherein
the receiving space is of a flexible size.

8. The scale system according to claim 7, wherein
the receiving space wall has a modular design such that the size of the receiving space can be adapted by using or not using at least one removable receiving space wall element.

9. The scale system according to claim 2,
wherein the receiving space wall is formed by at least two separable wall parts separable from each other for opening the receiving space to remove a powder container and to insert a powder container.

10. The scale system according to claim 9, wherein
the wall parts are connectable to one another by a snap connection.

11. The scale system according to claim 9, wherein
the wall parts are connectable to one another by a threaded connection.

12. The scale system according to claim 11, wherein
the wall parts are formed, at least in sections, as circular-cylindrically shaped wall components.

13. The scale system according to claim 2, wherein
the receiving space wall is connected to the weighing surface and forms a part of the weight sensed by the weighing sensor.

14. The scale system according to claim 13, wherein
the receiving space wall is at least partially formed integrally with the weighing surface, the receiving space wall and the weighing surface together forming a receptacle open at an upper end.

15. The scale system according to claim 2, wherein
the receiving space includes a window such that imprints on the powder container are readable when the powder container is arranged in the receiving space.

16. The scale system according to claim 1, wherein:
the evaluation device is configured to determine during a stepwise removal of a partial mass from the weighing surface the partial mass already removed by comparing the mass currently measured by the weighing sensor with a previously recorded reference mass prior to the removal; and
the evaluation device is configured to generate output data on basis of the partial mass already removed and to display said output data on the display device, said output data reflecting the partial mass removed since the recordation of the reference mass and said output data comprise a growing output value representing the removed partial mass.

17. The scale system according to claim 1, wherein
the evaluation device is configured:
to determine the partial mass of a single removal in the course of a stepwise increase of the removed partial mass, and
to compare the partial mass of the single removal with an expected mass of a scoop filling quantity powder.

18. The scale system according to claim 1, wherein
on the weighing surface or in the receiving space of the scale system a powder container is arranged.

19. The scale system according to claim 18,
the powder container is formed at least predominantly from cardboard and/or multiple paper layers.

20. The scale system according to claim 1, wherein
the scale system has two subunits, including a main unit comprising at least the base housing, the weighing surface and the weighing sensor, and an additional unit comprising at least the display device.

21. The scale system according to claim 1, wherein
the scale system has at least one further sensor in addition to the weighing sensor, the at least one further sensor comprising one of the following:
a sensor for detecting a marking applied to the powder container;
a sensor for mechanically detecting the opening of the lid of the scale system; or
an accelerometer for detecting movement of the scale system.

22. The scale system according to claim 1, wherein:
the scale system has a signaling mechanism configured to indicate by signalizing a pending removal of powder; and/or
the scale system has a logging mechanism configured to log the removal of powder and/or an expected, but missing removal of powder;
the scale system can be disassembled without tools, whereby at least the base housing and the weighing sensor are separable from each other without tools; and/or
the evaluation device is operable in a low-power mode in which at least the weighing sensor is deactivated or sensor data of the weighing sensor is not evaluated;
a power connection is disposed on the base housing and/or;
the evaluation device is configured to store a history of removal events together with data regarding the removed mass in course of the removal and/or;
the scale system comprises a scoop, and/or the scale system comprises a leveling rim for wiping excess powder from the scoop, and/or a volume of the scoop is stored in the evaluation device for determining the mass unit, and/or a mass of the scoop is stored in the evaluation device for inclusion in a calculation regarding the already removed partial mass, and/or the scale system comprises a scoop holder for storing the scoop when not in use, said scoop holder being provided on the base housing or stationary to the weighing surface.
